(19) United States
(12) Patent Application Publication
(10) Pub. No.: US 2021/0320381 A1
(43) Pub. Date: Oct. 14, 2021

(54) BATTERY SEPARATOR COATING

(71) Applicant: SOLVAY SPECIALTY POLYMERS ITALY S.P.A., Bollate (IT)

(72) Inventor: Elena MOLENA, Bollate (IT)

(21) Appl. No.: 17/264,950

(22) PCT Filed: Aug. 1, 2019
(86) PCT No.: PCT/EP2019/070828

§ 371 Date: Feb. 1, 2021

(30) Foreign Application Priority Data
Aug. 2, 2018 (EP) 18187063.5

(51) Int. Cl. H01M 50/451; C09D 127/16; C09D 7/61; H01M 50/403; H01M 10/0525

(52) U.S. Cl. CPC H01M 50/451; C09D 127/16; H01M 10/0525; H01M 50/403; C09D 7/61

(57) ABSTRACT

The present invention pertains to a vinylidene fluoride polymer aqueous dispersion, to a method for its preparation and to its use for the manufacture of electrochemical cell components, such as electrodes and/or separators.

### CROSS-REFERENCE TO RELATED APPLICATIONS

This application claims priority to European application No. 18187063.5 filed on 2 Aug. 2018, the whole content of those applications being incorporated herein by reference for all purposes.

### TECHNICAL FIELD

The present invention pertains to a vinylidene fluoride polymer aqueous dispersion, to a method for its preparation and to its use for the manufacture of electrochemical cell components, such as electrodes and/or separators.

### BACKGROUND ART

Lithium-ion batteries have become essential in our daily life. In the context of sustainable development, they are expected to play a more important role because they have attracted increasing attention for uses in electric vehicles and renewable energy storage.

Separator layers are important components of batteries. These layers serve to prevent contact of the anode and cathode of the battery while permitting electrolyte to pass there through. Additionally, battery performance attributes such as cycle life and power can be significantly affected by the choice of separator.

Vinylidene fluoride (VDF) polymers are known in the art to be suitable as binders for the manufacture of electrodes and/or composite separators, and/or as coatings of porous separators for use in non-aqueous-type electrochemical devices such as batteries, preferably secondary batteries, and electric double layer capacitors, and the use of aqueous dispersions of VDF polymers possessing all required properties for being used in the field of components for secondary batteries, has been attempted.

Inorganic filler materials have also been used in separator layers, being incorporated in the polymeric binder matrix with the aim of improving the thermal stability of the separators. Such inorganic filler materials include silica, alumina and TiO₂.

WO 2013/120858 (SOLVAY SPECIALTY POLYMERS ITALY SPA) 22/08/2013 is directed to a process for the manufacture of a composite separator for an electrochemical cell, said process comprising the following steps: (i) providing a substrate layer;
(ii) providing a coating composition comprising:
   an aqueous latex comprising at least one VDF polymer latex, and
   at least one non-electroactive inorganic filler material;
(iii) applying said coating composition onto at least one surface of said substrate layer to provide a coating composition layer; and
(iv) drying said coating composition layer.

Composite separators including polyvinyl alcohol (PVA) as a binder are also known in the art. LINGHUI, Yu. Ceramic coated polypropylene separators for lithium-ion batteries with improved safety: effects of high melting point organic binder. RSC Adv., 2016, 6, p. 40002-40009, discloses alumina/PVA coated polypropylene separators that show good thermal stability and reduced thermal shrinkage in comparison with separators comprising VDF polymer binders.

Lamination is an important process in battery cell assembly and could improve the battery performance characteristics and the ease of handling during manufacturing. The lamination process includes the step of contacting a separator with the electrodes in a facing relationship under certain pressure and temperature, to form a separator layer between opposite electrodes. The lamination process may be solvent assisted (wet lamination), involving the soaking of the separator in electrolyte fluid followed by lamination onto battery cell electrodes.

A properly laminated interface will often have lower impedance (resistance) than one which is not laminated, and would thereby improve the power characteristics of a cell.

In the technical field of batteries, notably of lithium batteries, the problem of providing a coated separator capable of providing good outstanding adhesion to the separator substrate material and which at the same time improves the adhesion of the separator to electrodes and has good lamination strength, porosity and conductivity, is felt.

### SUMMARY OF INVENTION

Accordingly, the Applicant faced the problem of providing a composition suitable for coating the substrate material of a separator for an electrochemical cell, said composition being such to provide at the same time outstanding adhesion to the separator base material and improved adhesion of the coated separator to electrodes, to cathode in particular, thus improving the long term performances of the battery.

Surprisingly, the Applicant found that when a separator for an electrochemical cell is at least partially coated with an aqueous composition comprising at least one vinylidene fluoride copolymer and at least a water soluble high molecular weight polyvinyl alcohol (PVA), said problem can be solved.

Thus, in a first aspect, the present invention relates to an aqueous composition [composition (C)] for use in the preparation of separators for electrochemical devices, said composition comprising:
a) at least one vinylidene fluoride (VDF) copolymer [polymer (A)], said polymer (A) comprising more than 85.0% moles of recurring units derived from vinylidene fluoride (VDF) monomer;
   and
b) at least one polyvinyl alcohol (PVA) having a viscosity greater than 50 mPa·s, as measured according to DIN 53015 on a 4% wt aqueous solution at 20° C.

In a second aspect, the present invention provides a process for preparing the aqueous composition (C) as above defined, said process comprising mixing:
an aqueous dispersion comprising particles of at least one polymer (A) as above defined [dispersion (D)];
an aqueous solution of at least one PVA as above defined [PVA solution].

In a third aspect, the present invention pertains to the use of the aqueous composition (C) of the invention in a process for the preparation of a separator for an electrochemical cell, said process comprising the following steps:
i) providing a non-coated substrate layer [layer (P)];
ii) providing composition (C) as defined above;
iii) applying said composition (C) obtained in step (ii) at least partially onto at least one portion of said substrate layer (P), thus providing an at least partially coated substrate layer; and
iv) drying said at least partially coated substrate layer obtained in step (iii).

In a further aspect, the present invention relates to a separator for an electrochemical cell comprising a substrate layer [layer (P)] at least partially coated with composition (C) as defined above.

In a further aspect, the present invention relates to an electrochemical cell, such as a secondary battery or a capacitor, comprising the at least partially coated separator as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content of a liquid composition, weight percent (wt %) indicates the ratio between the weight of all non-volatile ingredients in the liquid.

By the term “separator”, it is hereby intended to denote a porous monolayer or multilayer polymeric material which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

The separator for an electrochemical cell of the present invention can advantageously be an electrically insulating composite separator suitable for use in an electrochemical cell. When used in an electrochemical cell, the composite separator is generally filled with an electrolyte which advantageously allows ionic conduction within the electrochemical cell.

By the term “composite separator”, it is hereby intended to denote a separator as defined above wherein non-electroactive inorganic filler materials are incorporated into a polymeric binder material. The composite separator obtained according to the invention is advantageously an electrically insulating composite separator suitable for use in an electrochemical cell.

By the term “aqueous”, it is hereby intended to denote a medium comprising pure water and water combined with other ingredients which do not substantially change the physical and chemical properties exhibited by water.

Polymer (A) may further comprise recurring units derived from at least one hydrophilic (meth)acrylic monomer (MA) of formula:

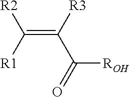

wherein each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group.

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

The hydrophilic (meth)acrylic monomer (MA) preferably complies with formula:

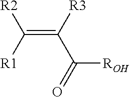

wherein each of R1, R2, R_{OH} have the meanings as above defined, and R3 is hydrogen; more preferably, each of R1, R2, R3 are hydrogen, while R_{OH} has the same meaning as above detailed.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

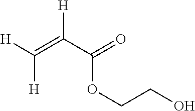

2-hydroxypropyl acrylate (HPA) of either of formulae:

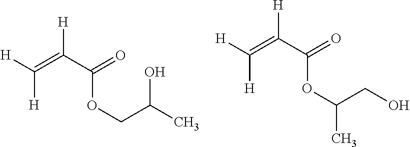

acrylic acid (AA) of formula:

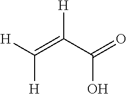

and mixtures thereof.

More preferably, the monomer (MA) is AA and/or HEA, even more preferably is AA.

Determination of the amount of (MA) monomer recurring units in polymer (A) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture and of IR methods.

Should at least one hydrophilic (meth)acrylic monomer (MA) be present, the polymer (A) comprises typically from 0.05 to 10.0% moles, with respect to the total moles of recurring units of polymer (A).

The polymer (A) may further comprise recurring units derived from at least one other comonomer (CM) different from VDF and from monomer (MA), as above detailed.

The comonomer (CM) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (CM) is preferably a fluorinated comonomer [comonomer (F)].

Non-limitative examples of suitable fluorinated comonomers (F) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula:

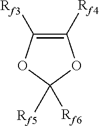

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

Should at least one comonomer (CM) (preferably HFP) be present, the polymer (A) comprises typically from 0.05% to 14.5% by moles, preferably from 1.0% to 13.0% by moles, of recurring units derived from said comonomer(s) (CM), with respect to the total moles of recurring units of polymer (A).

However, it is necessary that the amount of recurring units derived from vinylidene fluoride in the polymer (A) is at least 85.0 mol %, preferably at least 86.0 mol %, more preferably at least 87.0 mol %, so as not to impair the excellent properties of vinylidene fluoride resin, such as chemical resistance, weatherability, and heat resistance.

According to certain embodiments, polymer (A) consists essentially of recurring units derived from VDF and from monomer (MA).

According to other embodiments, polymer (A) consists essentially of recurring units derived from VDF, from HFP and from monomer (MA).

Polymer (A) may still comprise other moieties such as defects, end-groups and the like, which do not affect nor impair its physico-chemical properties.

One of the important features of the present invention is to use PVA having a viscosity greater than 50 mPa·s, as measured according to DIN 53015 on a 4% wt aqueous solution at 20° C.

Polyvinyl alcohols are commercially available and may be obtained over a range of molecular weights and degree of hydrolysis.

All water soluble grades of fully and partially hydrolyzed polyvinyl alcohol having a viscosity greater than 50 mPa·s, preferably greater than 80 mPa·s, as measured according to DIN 53015 on a 4% wt aqueous solution at 20° C., can be employed in the aqueous composition of the present invention.

The weight average molecular weight of the PVA suitable for use in composition (C) is preferably higher than 100.000, preferably higher than 130.000, determined by means of gel permeation chromatography (GPC) technique using the following conditions:

| Eluent | DMSO, Flux: 0.7 mL/min; |
|---|---|
| Solution concentration | about 0.1 % w/v in DMSO; |
| Pump | Waters Isocratic Pump model 515; |
| Injection system | Waters 2707 Autosampler. |
| Injection volume | 200 μl; |
| Columns | Three PLgel (mixed C, mixed C e |
| | mixed D) at 50° C.; |
| Detector | Waters refractive index model |
| | 2414. T detector: 50° C. |

Generally, a polyvinyl alcohol is prepared by hydrolysis of a polyvinyl alcohol precursor (polyvinyl acetate) obtained from polymerization of vinyl acetate (CH₃COOCHCH₂), as shown in Scheme I below,

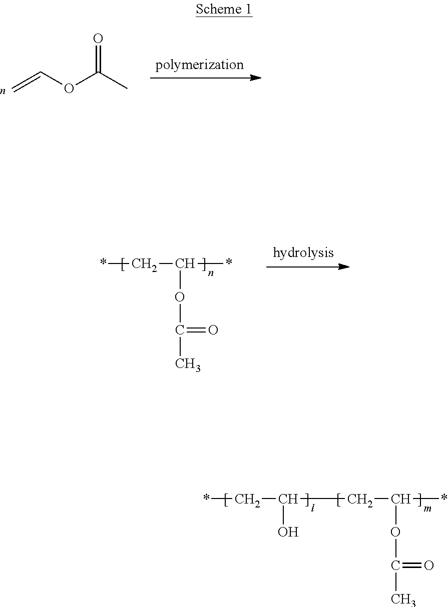

and the degree of saponification is defined as a degree of hydrolysis (degree of saponification=l/(l+m).

The degree of saponification of the PVA used in the aqueous composition of the present invention is preferably of at least 85%.

The composition (C) of the invention preferably comprises a non-electroactive inorganic filler material.

By the term “non-electroactive inorganic filler material”, it is hereby intended to denote an electrically non-conducting inorganic filler material, which is suitable for the manufacture of an electrically insulating separator for electrochemical cells.

The non-electroactive inorganic filler material in the separator according to the invention typically has an electrical resistivity (p) of at least 0.1×1010 ohm cm, preferably of at least 0.1×1012 ohm cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

The non-electroactive inorganic filler material is typically under the form of particles having an average size of from 0.01 μm to 50 μm, as measured according to ISO 13321.

The amount of polymer (A) used in the aqueous composition (C) of the present invention, will vary from about 15.0 to 97.0 wt %, wherein said weight percentage is based on the total solid content weight of the aqueous composition (C).

The amount of PVA used in the aqueous composition (C) of the present invention will vary from about 2.0 to 10.0 wt %, more preferably from about 2.5 and about 5.0 wt %, wherein said weight percentage is based on the total solid content weight of the aqueous composition (C).

Typically, the non-electroactive inorganic filler material is present in an amount of from 10.0 wt % to 90.0 wt %, preferably from 50.0 wt % to 88.0 wt % or from 70.0 wt % to 85.0 wt %, wherein said weight percentage is based on the total solid content weight of the aqueous composition (C).

The composition (C) may further comprise one or more than one additional additive.

Optional additives in composition (C) include notably viscosity modifiers, as detailed above, anti-foams, non-fluorinated surfactants, and the like.

Among non-fluorinated surfactants, mention can be made of non-ionic emulsifiers, such as notably alkoxylated alcohols, e.g. ethoxylates alcohols, propoxylated alcohols, mixed ethoxylated/propoxylated alcohols; of anionic surfactants, including notably fatty acid salts, alkyl sulfonate salts (e.g. sodium dodecyl sulfate), alkylaryl sulfonate salts, arylalkyl sulfonate salts, and the like.

In a preferred embodiment of the present invention, the aqueous composition (C) comprises, preferably consists of:
(a) at least one polymer (A) as above defined, in an amount ranging from 90 to 97 wt %;
(b) at least one PVA as above defined, in an amount ranging from 2.0 to 10.0 wt %;
and
one or more than one additional additive, in an amount of from 0 to 5.0 wt %, wherein said weight percentages are based on the total solid content weight of the aqueous composition (C).

In another preferred embodiment of the present invention, the aqueous composition (C) comprises, preferably consists of:
(a) at least one polymer (A) as above defined, in an amount ranging from 10.0 to 30.0 wt %;
(b) at least one PVA as above defined, in an amount ranging from 2.0 to 10.0 wt %;
(c) at least one non-electroactive inorganic filler material in an amount ranging from 60.0 to 85.0 wt %; and one or more than one additional additive, in an amount ranging from 0 to 5.0 wt %, wherein said weight percentages are based on the total solid content weight of the aqueous composition (C).

Typically, the total solid content of the composition (C) ranges between 15 and 50 wt % over the total weight of the composition (C).

The total solid content of the composition (C) is understood to be cumulative of all non-volatile ingredients thereof, notably including polymer (A), PVA and non-electroactive inorganic filler material.

For the purpose of the present invention, the dispersion (D) is intended to denote an aqueous dispersion of a VDF copolymer derived from aqueous emulsion polymerization, which is distinguishable from a suspension that could be obtained by a conditioning step of such copolymer manufacture such as concentration and/or coagulation of aqueous latexes of the polymer.

The dispersion (D) in the composition (C) of the invention is thus distinguishable from an aqueous slurry prepared by dispersing powders a polymer or of a copolymer in an aqueous medium.

Dispersion (D) comprises the at least one polymer (A) in a weight percent amount ranging from 20% to 50%, over the total weight of dispersion (D).

Dispersion (D) may be obtained by aqueous emulsion polymerization of VDF and the hydrophilic (meth)acrylic monomer (MA) and, optionally, the at least one comonomer (CM) as above defined, in the presence of a persulfate inorganic initiator, at a temperature of at most 90° C., under a pressure of at least 20 bar.

The aqueous emulsion polymerization is typically carried out as described in the art (see e.g. EP3061145, WO 2018/011244 and WO 2013/010936).

For the purposes of the present invention, dispersion (D) can be used directly as obtained from the polymerization as above described. In this case, the dispersion (D) has a content of the at least one polymer (A) ranging from 20% to 30% by weight over the total weight of dispersion (D).

Optionally, subsequent to the emulsion polymerization, the method of making dispersion (D) may further include a concentration step. The concentration can be notably carried out with anyone of the processes known in the art. As an example, the concentration can be carried out by an ultrafiltration process well-known to those skilled in the art. See, for example, U.S. Pat. Nos. 3,037,953 and 4,369,266.

After the concentration step, the dispersion (D) may have a content of the at least one polymer (A) up to at most about 50% by weight.

Dispersion (D) may further comprise at least one non-ionic surfactant stabilizer, preferably belonging to the class of alkylphenols ethoxylates. The amount of non-ionic surfactant in dispersion (D) can range from 2 to 20% by weight over the total weight of dispersion (D).

For the purpose of the present invention, the PVA solution is a solution in demineralized water of at least one polyvinyl alcohol as above defined, wherein the weight percentage amount of polyvinyl alcohol over the total weight of the PVA solution ranges from 2 to 15% by weight.

Generally, the composition (C) is obtained by mixing:
(i) a dispersion (D), as above detailed;
(ii) a PVA solution, as above detailed;
(iii) optionally, at least one non-electroactive inorganic filler material, as above detailed;
(iv) optionally, one or more than one additional additive; and optionally, adding water for adjusting the total solid content in the range of 15 to 50% wt.

Composition (C) is particularly suitable for the coating of surfaces, particularly of porous surfaces such as that of separators for electrochemical cells.

The aqueous composition according to the invention is particularly advantageous for the preparation of coated or semi-coated separators suitable for use in Lithium-based secondary batteries, such as lithium-ion and lithium metal secondary batteries.

In one aspect, the present invention thus pertains to the use of the composition (C) in a process for the preparation of a separator for an electrochemical cell, said process comprising the following steps:
i) providing a non-coated substrate layer [layer (P)];
ii) providing composition (C) as defined above;
iii) applying said composition (C) obtained in step (ii) at least partially onto at least one portion of said substrate layer (P), thus providing an at least partially coated substrate layer; and
iv) drying said at least partially coated substrate layer obtained in step (iii).

In the context of the invention, the term “substrate layer” is hereby intended to denote either a monolayer substrate consisting of a single layer or a multilayer substrate comprising at least two layers adjacent to each other.

The thickness of layer (P) is not particularly limited and is typically from 3 to 100 micrometer, preferably from 5 to 50 micrometer.

The layer (P) can be made by any porous substrate or fabric commonly used for a separator in electrochemical device, comprising at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene and polypropylene, or their mixtures. Preferably, the layer (P) is polyethylene or polypropylene.

In step (iii) of the process of the invention, the composition (C) is typically applied onto at least one surface of the substrate layer (P) by a technique selected from casting, spray coating, rotating spray coating, roll coating, doctor blading, slot die coating, gravure coating, ink jet printing, spin coating and screen printing, brush, squeegee, foam applicator, curtain coating, vacuum coating.

In step (iv) of the method of the invention, the coating composition layer is dried preferably at a temperature comprised between 60° C. and 200° C., preferably between 70° C. and 180° C.

In a further aspect, the present invention relates to a separator for an electrochemical cell comprising a substrate layer [layer (P)] at least partially coated with composition (C) as defined above.

The separator for an electrochemical cell of the invention preferably comprises a non-electroactive inorganic filler material uniformly distributed within the composition (C) polymeric matrix.

The inventors found that in the separator according to the invention the adhesion of the composition (C) as defined above to substrate layer (P) is remarkably higher than that obtainable using a coating composition comprising exclusively the at least one vinylidene fluoride (VDF) copolymer and also higher than that obtainable using a coating composition comprising the at least one vinylidene fluoride (VDF) copolymer together with a polyvinyl alcohol having a low viscosity.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

### Experimental Part

Raw Materials

Alumina, commercially available as CR6® from Baikowski PVA A, commercially available as POVAL™ 95-88 from Kurarai PVA B, commercially available as POVAL™ 6-88 from Kurarai

Dispersion A: VDF-AA polymer containing 99.55% by moles of VDF and 0.45% by moles of acrylic acid (AA) monomer, obtained as described in WO 2018/011244. Solid content=24.2% wt.

Dispersion B: VDF-HFP-AA polymer containing 96.13% by moles of VDF, 2.97% by moles of HFP and 0.9% by moles of acrylic acid (AA) monomer, obtained as described in WO 2018/011244. Solid content=22 wt %.

Dispersion C: VDF-HFP-AA polymer containing 96.13% by moles of VDF, 2.97% by moles of HFP and 2.97% by moles of acrylic acid (AA) monomer, obtained as described in WO 2018/011244. Solid content=22 wt %.

Dispersion D: VDF-HFP-AA polymer containing 86.72% by moles of VDF, 12.38% by moles of HFP and 0.9% by moles of acrylic acid (AA) monomer, obtained as described in WO 2018/011244. Solid content=22 wt %.

Polyolefin substrate: commercially available as Tonen® F₂OBHE, PE material, 20 μm, 45% porosity.

Dispersing agent: BYK LPC 22134, commercially available from BYK.

Wetting agent: polyether side chains and silicone backbone, commercially available as BYK 349 from BYK.

Procedure for the Preparation of Coated Composite Separators C-1, C-2, C-3, C-4, Comp-3 and Comp-4

As preliminary stage, PVA was dissolved in deionized water at 10 wt % by means of a shear mixing. Then alumina and the dispersing agent were added to the said mixture together and everything is submitted to high shear mixing at 3000 rpm for 30 min. Then, the VDF-based dispersion was added, optionally together with the wetting agent, and mixed at 500 rpm for 10 min.

The dispersing agent was added in an amount of 1 wt % based on the total solid content of the composition.

The optional wetting agent was added in an amount of 1 wt % based on the total solid content of the composition.

The components were mixed in the relative percentage amount shown in Table 1.

TABLE 1

| | | | | Dispersing | Wetting |
|---|---|---|---|---|---|
| | Dispersion | Filler | PVA | agent | agent |
| C-1 | A | Al₂O₃ | A | | |
| | 21% | 73% | 4% | 1% | 1% |
| C-2 | B | Al₂O₃ | A | | |
| | 21% | 73% | 4% | 1% | 1% |
| C-3 | C | Al₂O₃ | A | | |
| | 21% | 74% | 4% | 1% | — |
| C-4 | D | Al₂O₃ | A | | |
| | 21% | 74% | 4% | 1% | — |
| Comp-3 | A | Al₂O₃ | B | | |
| | 21% | 73% | 4% | 1% | 1% |
| Comp-4 | B | A1203 | B | | |
| | 21% | 73% | 4% | 1% | 1% |

Then, water was added to obtain a solid content of about 40 wt %.

Casting was performed on polyolefin at 30 μm of wet thickness to achieve a final dry coating of 5 μm. Drying was performed at 70° C. for 30 min in ventilated oven.

Procedure for the Preparation of Coated Separators C-5, C-6, C-7 and C-8

As preliminary stage, PVA was dissolved in deionized water at 10 wt % by means of a shear mixing. Then the VDF-based dispersion was added to the said mixture together with the wetting agent (in an amount of 1 wt % based on the total solid content of the composition) and everything was mixed together at 500 rpm for 10 min.

The components were mixed in the relative percentage amount shown in Table 2.

TABLE 2

| COMPOSITION | Dispersion | PVA |
|---|---|---|
| C-5 | B | A |
| | 96% | 4% |
| C-6 | B | A |
| | 92% | 8% |
| C-7 | D | A |
| | 96% | 4% |
| C-8 | C | A |
| | 96% | 4% |

Then, water was added to obtain a solid content of about 23 wt %.

Casting was performed on polyolefin at 30 μm of wet thickness to achieve a final dry coating of 2 μm. Drying was performed at 70° C. for 30 min in ventilated oven.

Procedure for the Preparation of Coated Composite Separators Comp-1 and Comp-2

Alumina and the dispersing agent were added to water and everything is submitted to high shear mixing at 3000 rpm for 30 min. Then, the VDF-based dispersion was added together with the wetting agent and mixed at 500 rpm for 10 min.

The wetting agent was added in an amount of 1 wt % based on the total solid content of the composition. The dispersing agent was added in an amount of 1 wt % based on the total solid content of the composition.

The components were mixed in the relative percentage amount shown in Table 3.

TABLE 3

| | | | | Dispersing | Wetting |
|---|---|---|---|---|---|
| | Dispersion | Filler | PVA | agent | agent |
| Comp-1 | A | Al₂O₃ | B | | |
| | 21% | 73% | 4% | 1% | 1% |
| Comp-2 | B | Al₂O₃ | B | | |
| | 21% | 73% | 4% | 1% | 1% |

In order to verify the adhesion of the coating to the polyolefin substrate peeling tests were performed. An adhesive tape was attached to the surface of the coating and the coating was peeled off from substrate at 300 mm/min and 180°. The results are shown in Table 4.

TABLE 4

| | Coating adhesion |
|---|---|
| COMPOSITION | [N/m] |
| C-1 | 71 ± 17 |
| C-2 | 57 ± 15 |
| C-5 | 29 ± 4 |
| C-6 | 63.5 ± 0.7 |
| C-7 | 645 ± 29 |
| Comp-1 | 0.7 |
| Comp-2 | 2 |
| Comp-3 | 8 ± 1 |
| Comp-4 | 22 ± 2 |

A substantial increase in adhesion of the coating to the substrate layer, with respect to the comparative composition comprising low viscosity PVA and with respect to the comparative composition comprising only the VDF copolymer, was observed for coating compositions comprising high viscosity PVA.

Characterization of Composite Separator: Wet Adhesion Post 48 h in EC: DMC

Wet lamination is the evaluation of the wet adhesion of the separator to cathode with the addition of alkyl carbonate mixture solvent. The coated separators prepared as above detailed and the same cathode as above detailed, under the form of specimens having dimensions of 11 cm×8 cm, were pre-conditioned by drying at 55° C. overnight in hot oven and then brought in glove box. The separator was immersed in PC for 5 min and the wet separator was then laid on cathode surface. The separator-cathode assembly was sealed in vacuum in a coffee bag within 2 PTFE sheets and then pressed with a flat hydraulic press at 80° C., 1 MPa, 5 min.

After lamination the coffee bag was opened and samples of 10×2 cm² were prepared. Finally the separator was peeled off from cathode surface with peeling angle of 180° at a peeling rate of 300 mm/min following. Two trials were carried out: Trial 1 and Trial 2 for each specimen. Results are summarized in the following Table 5.

TABLE 5

| | Wet adhesion | Wet adhesion | |
|---|---|---|---|
| | [N/m] | [N/m] | Delamination |
| COMPOSITION | Trial 1 | Trial 2 | interface |
| C-1 | 1.2 ± 0.1 | 1.5 ± 0.2 | Coating-cathode |
| C-2 | 0.43 ± 0.05 | 0.42 ± 0.05 | Coating-cathode |
| C-3 | 0.89 ± 0.08 | 0.87 ± 0.08 | |
| C-4 | 1 ± 0.04 | 1.1 ± 0.3 | |
| C-5 | 20.1 ± 0.9 | 19 ± 1 | |
| C-6 | 23 ± 1 | 24 ± 2 | |
| C-7 | 0.4 ± 0.1 | 0.7 ± 0.3 | |
| C-8 | 43 ± 3 | 48 ± 6 | |
| Comp-3 | 1.55 ± 0.07 | 3.1 ± 0.5 | Polyolefin-coating |
| Comp-4 | 0.4 ± 0.1 | 0.4 ± 0.03 | Coating-cathode |

The significant improvement in adhesion to the polyolefin of compositions with high viscosity PVA improves significantly the quality of wet lamination data. Better reproducibility is obtained as can be observed from standard deviation and the delamination interface moves from polyolefin-separator coating to separator coating-cathode interface.

1-16. (canceled)

17. An aqueous composition [composition (C)] for use in the preparation of separators for electrochemical devices comprising:
a) at least one vinylidene fluoride (VDF) copolymer [polymer (A)], said polymer (A) comprising more than 85.0% moles of recurring units derived from vinylidene fluoride (VDF) monomer;
and
b) at least one polyvinyl alcohol (PVA) having a viscosity greater than 50 mPa·s, as measured according to DIN 53015 on a 4% wt aqueous solution at 20° C.

18. The composition (C) according to claim 17, wherein the polymer (A) further comprises recurring units derived from at least one hydrophilic (meth)acrylic monomer (MA) of formula: 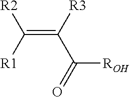
wherein each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group.

19. The composition (C) according to claim 18, wherein the recurring units derived from at least one hydrophilic (meth)acrylic monomer (MA) are selected from the group consisting of: acrylic acid, methacrylic acid, hydroxyethyl (meth)acrylate, hydroxypropyl (meth)acrylate; hydroxyethylhexyl(meth)acrylates.

20. The composition (C) according to anyone of claim 18, wherein the recurring units derived from at least one hydrophilic (meth)acrylic monomer (MA) are comprised in polymer (A) in an amount of least 0.1% moles and at most 10% moles.

21. The composition (C) according to claim 17, wherein polymer (A) further comprises recurring units derived from at least one comonomer (CM), different from VDF and from monomer (MA).

22. The composition (C) according to claim 21, wherein comonomer (CM) is a fluorinated comonomer [comonomer (F)] selected from the group consisting of:
(a) C₂-C₈ fluoro- and/or perfluoroolefins;
(b) C₂-C₈ hydrogenated monofluoroolefins;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins;
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula: 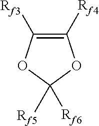
wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃,
preferably comonomer (F) being hexafluoropropylene (HFP).

23. The composition (C) according to claim 17, wherein the at least one PVA has a degree of saponification of at least 85%.

24. The composition (C) according to claim 17, wherein the at least one PVA has a weight average molecular weight higher than 100.000, determined by means of gel permeation chromatography (GPC) technique.

25. The composition (C) according to claim 17 that further comprises a non-electroactive inorganic filler material.

26. The composition (C) according to claim 17 that comprises:
(a) at least one polymer (A), in a weight percent amount over the total weight of the composition (C) ranging from 90 to 97 wt %;
(b) at least one PVA, in a weight percent amount over the total weight of the composition (C) ranging from 2.0 to 10.0 wt %; and
(c) one or more than one additional additive, in an amount of 0 to 5.0 wt %, wherein said weight percentages are based on the total solid content weight of the aqueous composition (C).

27. The composition (C) according to claim 17 that comprises:
(a) at least one polymer (A), in a weight percent amount over the total weight of the composition (C) ranging from 10.0 to 30.0 wt %;
(b) at least one PVA, in a weight percent amount over the total weight of the composition (C) ranging from 2.0 to 10.0 wt %;
(c) one or more than one additional additive, in an amount of 0 to 5 wt %,
(d) at least one non-electroactive inorganic filler material in a weight percent amount over the total weight of the composition (C) ranging from 60.0 to 85.0 wt %;
wherein said weight percentages are based on the total solid content weight of the aqueous composition (C).

28. Process for preparing the aqueous composition (C) according to claim 17, the processes comprising mixing:
an aqueous dispersion comprising particles of at least one polymer (A) according to claim 17 [dispersion (D)];
an aqueous solution of at least one PVA according to claim 17 [PVA solution].

29. Use of the aqueous composition (C) according to claim 17 in a process for the preparation of a separator for an electrochemical cell, said process comprising the following steps:
i) providing a non-coated substrate layer [layer (P)];
ii) providing a composition (C) according to claim 17;
iii) applying said composition (C) obtained in step (ii) at least partially onto at least one portion of said substrate layer (P), thus providing an at least partially coated substrate layer; and
iv) drying said at least partially coated substrate layer obtained in step (iii).

30. A separator for an electrochemical cell comprising a substrate layer [layer (P)] at least partially coated with composition (C) according to claim 17.

31. An electrochemical cell, comprising the at least partially coated separator according to claim 30.

32. The electrochemical cell according to claim 31 that is a secondary battery.
